(19) United States
(12) Patent Application Publication
(10) Pub. No.: US 2010/0300314 A1
(43) Pub. Date: Dec. 2, 2010

(54) Stamp Structure

(76) Inventor: Ying-I CHEN, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,130

(22) Filed: Jun. 2, 2009

(51) Int. Cl. B41K 1/56

(52) U.S. Cl. 101/405

(57) ABSTRACT

A stamp structure comprises a stamp pad and a handle. The stamp pad includes an image piece, a buffer piece, a twin adhesive, and an adhesion piece, arranged from bottom to top. A gum is located between the image piece and the buffer piece. The bottom surface of the handle has an adhesion area, which is selectively adhering on the adhesion piece. Since users can make the adhesion piece of the stamp pad to adhere or to detach on the adhesion area at their will, they can choose different stamp pads to adhere on the same handle. Compared with traditional stamp structure, the present invention can help to save the material of the handle and the room to accommodate the stamp.

### BACKGROUND OF THE INVENTION

1. Field of the Invention

The present invention relates to a stamp structure, in particular, to a stamp structure with a changeable stamp pad.

2. Description of Related Art

Stamps are some of the essential stationery for modern people. Even though the web stamp and digital signature become popular, most people still choose to use stamps and handwritten signatures in the legal documents, such as contracts. For children, it will be helpful to stimulate their imagination by giving them the stamp with image. Children can enjoy pressing the stamp on the paper and finishing images on the working paper at the same time. Further, children can also color the areas surrounded by the contour of those images, showing their imagination and art talent.

A conventional stamp structure comprises a stamp pad and a handle, and the stamp pad usually adheres to the handle. Since a stamp pad and a handle are essential elements to form a stamp structure, it may not be easy to drive down the material expenditure in the manufacturing process of the stamp structure. Therefore, when people need to use many stamps with different images, the stamps will cost them a lot. Besides, because the handle accounts for the most volume of the stamp structure, it is inevitable to use large amount of room to accommodate those stamps.

In order to tackle those drawbacks of the conventional stamp structure, another type of conventional stamp structure was created. Referring to FIG. 1 and FIG. 2, a stamp structure comprises a stamp pad 1a and a handle 2a. The stamp pad includes an image piece 11a, a buffer piece 12a, and a magnetic piece 13a, arranged from bottom to top. In general, the material of the image piece 11a is rubber. A protrusion 111a protrudes downward from the bottom surface of the image piece 11a. In FIG. 1 and FIG. 2, the protrusion is shown with “Z.” shape. The bottom surface of the buffer piece 12a adheres to the image piece 11a. The material of the buffer piece 12a is a kind of soft material, such as foam. The upper surface of the buffer piece 12a adheres to the magnetic piece 13a.

The handle 2a has a plurality of grooves on the bottom surface. The grooves were embedded with a plurality of iron strip 21a, each of which is corresponding to each of the grooves. When people use this kind of stamp structure, by means of the magnetic force between the magnetic piece 13a and the iron strip 21a, they can easily make the stamp pad 1a attach to the handle 2a and then make the stamp structure complete. The stamp pad 1a is detachable to the handle 2a. Others stamp with similar stamp structures to this kind of conventional stamp structure can attach or detach to the same handle 2a by the magnetic force.

However, this kind of conventional stamp structure still has several drawbacks. The depth of each groove of the handle 2a and the height each iron strip 21a determine whether the bottom surface of the handle is flat. The stamp pad may be partially inclined because of the uneven bottom surface of the handle 2a, and this situation will cause the protrusion 111a deformed. The protrusion 111a which is deformed will change the shape of the printing area 31a on the working paper 3a or make the ink unevenly distributed. Besides, when the location where the stamp pad 1a and the handle 2a combine is not close to the center of the handle 2a, and the users do not press this kind of conventional stamp structure evenly on the ink pad, not only the protrusion 111a but also the other part of the bottom surface of the image piece 11a will be dyed on the ink pad. Later, when the users press the stamp structure to the working paper 3a, because of uneven pressure, the protrusion 111a contacts to the working paper 3a to form the printing area 31a, and the other part of the bottom surface of the image piece 11a cause an error area 32a at the same time.

### SUMMARY OF THE INVENTION

The main object of the present invention is to provide a stamp structure, compared with the conventional stamp structure, the present invention which can reduce the material cost in manufacturing, save the room for accommodate the present invention and the stamp pad is changeable at the users' will.

To attain the object mentioned above, the present invention provides a stamp structure, comprising: a stamp pad, having an image piece, a buffer piece, a twin adhesive, and an adhesion piece arranged from bottom to top, wherein a gum is located between the image piece and the buffer piece; and a handle, wherein the bottom surface of the handle has an adhesive area, which is selectively adhering to the adhesion piece.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a partially exploded, schematic view of the conventional stamp structure;

FIG. 2 is a view of the conventional stamp structure in use;

FIG. 3 is an exploded, schematic view of the present invention;

FIG. 4 is an another exploded, schematic view of the present invention;

FIG. 5 is an abridged general view of the present invention;

FIG. 6 is a cross-sectional view of the present invention;

FIG. 7 is a top view of the locating image of the handle combining with the stamp pad of the present invention;

FIG. 8 is an exploded, schematic view of the stamp pad of the present invention not in use.

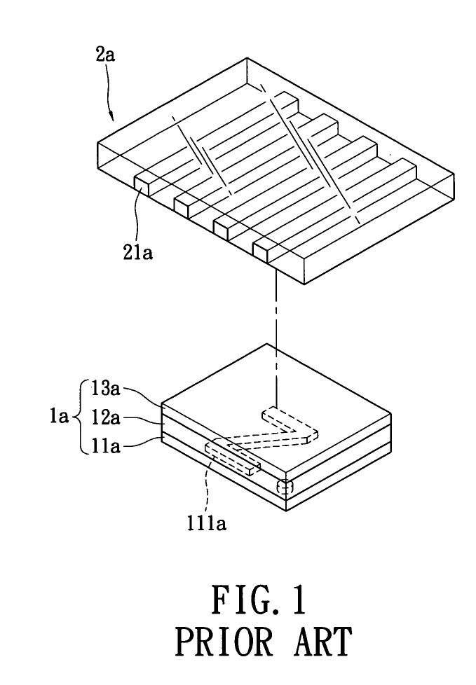

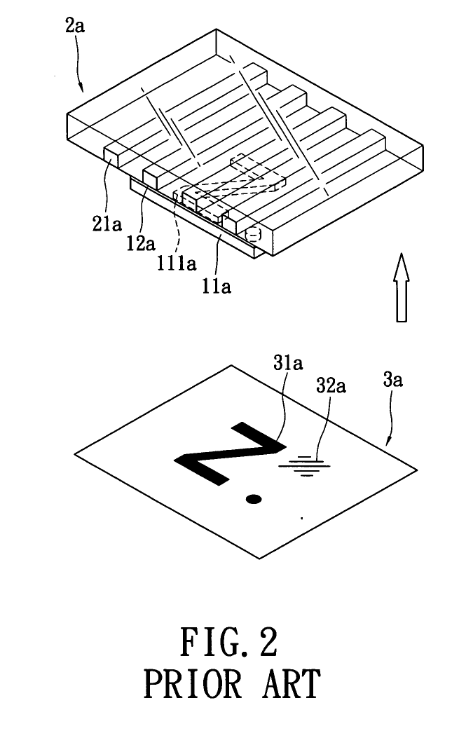

### DETAILED DESCRIPTION OF THE PREFERRED EMBODIMENTS

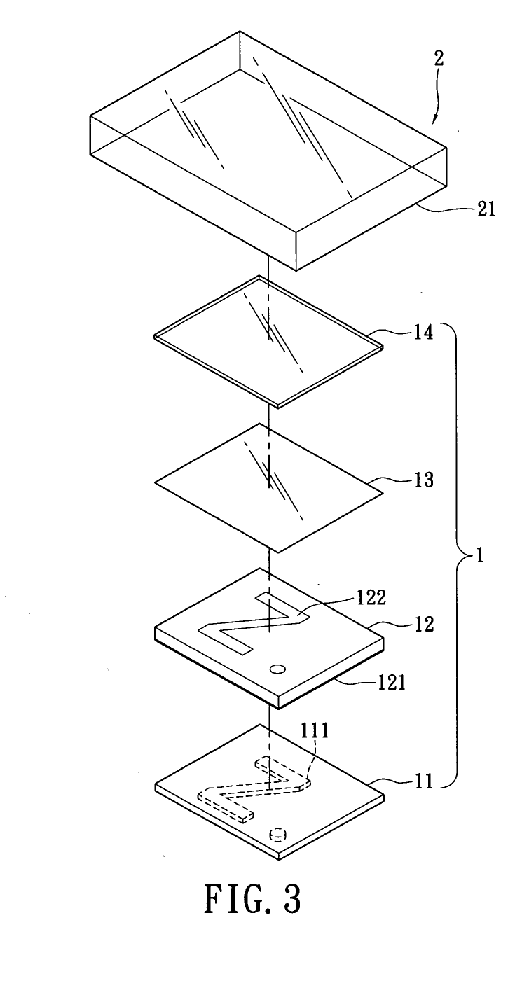

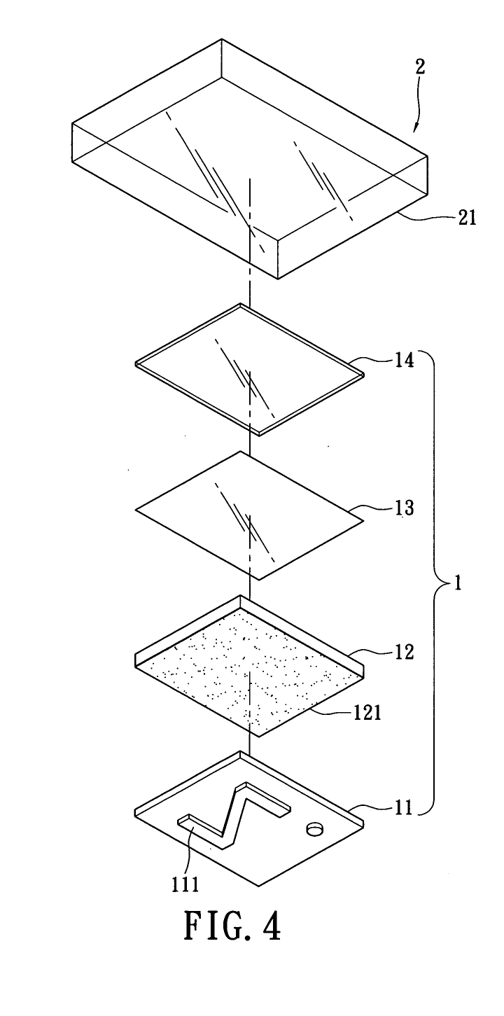

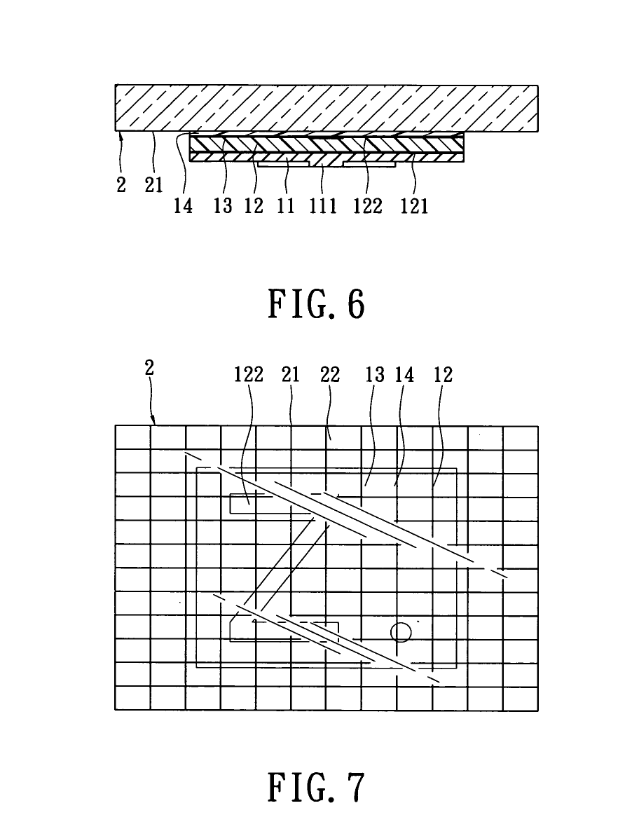

Please refer to FIG. 3 to FIG. 6. The present invention provides a stamp structure, comprising a stamp pad 1 and a handle 2. The stamp pad includes an image piece 11, a buffer piece 12, a twin adhesive 13, and an adhesion piece 14, arranged from bottom to top.

The material of the image piece 11 in this embodiment is rubber. The upper surface of the image piece 11 is flat. A protrusion 111 vertically protrudes downward from the bottom surface of the image piece 11. In this embodiment, the protrusion 111 is shown with “Z.” shape, but when in the realistic situation, the shape of the protrusion 111 is not limited. The image piece 11, along with the protrusion 111, was made by hot forming.

The material of the buffer piece 12 is a kind of soft material. In this embodiment, the material is foam, foamed by ethylene-vinyl acetate copolymer (EVA). Both the upper surface and bottom surface of the buffer piece 12 is flat. The bottom surface of the buffer piece 12 was smeared by a gum 121 evenly, by which the upper surface of the image piece 11 and the bottom surface of the buffer piece 12 can be stuck to each other. A corresponding image 122 was located on the upper surface of the buffer piece 12. In this embodiment, the corresponding image 122 is shown with “Z.” shape, but when in the realistic situation, the shape of the corresponding image 122 is not limited. The corresponding image 122 is ink or toner printed by the method of inkjet printing, laser printing, dyestuff printing, movable printing, or polychrome printing. The method of printing the corresponding image 122 on the buffer piece 12 is not limited. The size and the shape of the corresponding image 122 are identical to those of the image shown by the protrusion 111 of the image piece 11. The location of the corresponding image 122 is vertically corresponding to that of the image shown by the protrusion 111.

The twin adhesive 13 is a transparent slice. Both the upper surface and bottom surface of the twin adhesive 13 are adhesive. The base material in this embodiment can be polyethylene terephthalate (PET) or polyvinyl chloride (PVC). The material of the twin adhesive 13 is not limited. The bottom surface of the twin adhesive 13 is stuck to the upper surface of the buffer piece 12.

The adhesion piece 14 is also transparent. The material of the adhesion piece 14 is silicone. The adhesion piece 14 is stuck to the upper surface of the twin adhesive 13.

By means of the gum 121 located on the bottom surface of the buffer piece and the twin adhesive 13, the image piece 11, the buffer piece 12, and the adhesion piece 14 can combine together. Further, the materials of the twin adhesive 13 and adhesion piece 14 are transparent so that the users can look through the adhesion piece 14 and twin adhesive 13, and then look on the corresponding image 122 on the upper surface of the buffer piece 12.

The handle 2 is a transparent rectangular solid. The material of the handle 2 such as glass, plastic or acrylic glass does not have any pores on the surface. In this embodiment, the material of the handle 2 is glass. The bottom surface of the handle 2 is flat. The bottom surface is an adhesion area 21. The upper surface of the adhesion piece 14 can be selectively adhere to the adhesion area 21. Since the handle 2 in this embodiment is rectangular solid, the original upper surface of the handle 2 can be the new bottom surface of the handle 2 when the handle 2 is reversed.

Before the invention is in use, the users can put the handle 2 on the table. Afterward the user take at least one stamp pad 1 which is chosen by the users before and then make the stamp pad 1 reversed. The adhesion piece 14 faces down and correspond to the upper surface of the handle 2. Now the upper surface of the handle 2 is the adhesion area 21. The users use fingers to press the image piece 11 of the stamp pad 1 down, making the adhesion piece 14 adhere to the adhesion area 21. Afterward, when the users make the stamp pad 1 and handle 2 reverse back, the original upper surface of handle 2 turns out to be the new bottom surface of the handle 2, and the image piece 11 faces down, which is the status that the present invention is in use. The handle 2 is also transparent so that the users can look through the corresponding image 122 when the present invention is in use.

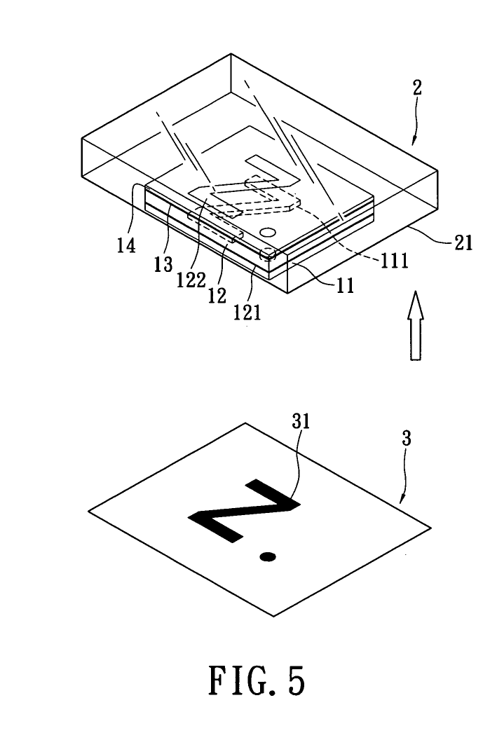

Later, press the present invention on the ink pad, making the protrusion 111 of the stamp pad 1 contacting on the surface of the ink pad. Then, press the present invention on the working paper 3 to dye the printing area 31, referring to FIG. 5. In this embodiment, the image of the printing area 31 is shown with “Z.” shape.

Referring to FIG. 7, a locating image 22 is located on the upper surface of the handle 2. In this embodiment, the locating image 22 includes a plurality of grid lines. When the users combine stamp pad 1 with handle 2, the locating image 22 will help the users to notice whether the stamp pad 1 is attached close to the center of the adhesion area 21 of the handle, and then to make a better printing performance. In other words, it is much less likely for the users to dye the bottom surface of the image piece 11 except protrusion 111. Or, when the users intend to attach a plurality of stamp pads on the handle, the locating image 22 is helpful for the users to attach those stamp pads in a better allocation.

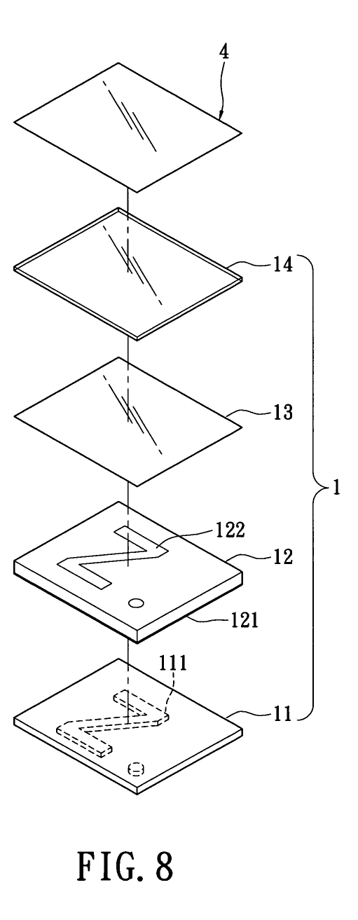

Besides, when the present invention is not in use, the stamp pad 1 is detachable to the handle 2. Referring to FIG. 8, a protecting piece 4 is located on the upper surface of the adhesion piece 14 of the stamp pad 1. The adhesion piece 14 adheres to the protecting piece 4 to prevent the adhesion piece 14 from contaminated by oil or dirt, which may influence the adhering effect between the adhesion piece 14 and the adhesion area 21.

To sum up, the present invention has several merits as follows:

1. The stamp pad is combined with the handle by the adhesion piece selectively adhere to the adhesion area. If the users want to attach a plurality of stamp pads on the handle and the area of the adhesion area is wide enough, only one handle can be attached on those stamp pads and be pressed on the working paper. Or, different stamp pads can attach and then detach on the handle one by one. When users want to accommodate the present invention, because only one handle is needed, the present invention can save more room to accommodate compared with conventional stamp structure.

2. Because the twin adhesive, adhesion piece, and the handle are composed of transparent materials, when the stamp pad is combined with the handle, the users can look through the corresponding image of the upper surface of the buffer surface. Therefore, when the present invention is about to pressed on the working paper, the users can measure the relative position where the protrusion of the image piece contact on the working paper by the corresponding image.

3. There is no extra settlement added on the handle. Therefore, the surfaces of the handle are flat. When the handle is combined with at least one stamp pad, the protrusion of the stamp pad will not be deformed so that the shape of the printing area on the working paper will not be deformed either. The ink of the printing area is evenly distributed.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A stamp structure, comprising:
a stamp pad, having an image piece, a buffer piece, a twin adhesive, and an adhesion piece arranged from bottom to top, wherein a gum is located between the image piece and the buffer piece; and
a handle, wherein the bottom surface of the handle has an adhesion area, and the adhesion area is selectively adhering to the adhesion piece.

2. The stamp structure as claimed in claim 1, wherein the adhesion area of the handle is selectively adhering to at least one stamp pad.

3. The stamp structure as claimed in claim 1, wherein the image piece has at least one protrusion, and the protrusion protrudes from the bottom surface of the image piece.

4. The stamp structure as claimed in claim 1, wherein the upper surface of the buffer surface has a corresponding image, and the materials of the twin adhesive, the adhesion piece, and the handle are transparent.

5. The stamp structure as claimed in claim 4, wherein the material of the adhesion piece is silicon, and the material of the handle does not have any pores on the surface.

6. The stamp structure as claimed in claim 5, wherein the material of the handle is glass.

7. The stamp structure as claimed in claim 5, wherein the material of the handle is acrylic glass.

8. The stamp structure as claimed in claim 5, wherein the material of the handle is plastic.

9. The stamp structure as claimed in claim 1, wherein the material of the buffer piece is foam.

10. The stamp structure as claimed in claim 1, wherein the upper surface of the handle has a locating image.
